(19) United States
(12) Patent Application Publication
(10) Pub. No.: US 2025/0341157 A1
(43) Pub. Date: Nov. 6, 2025

(54) TRANSFER LEARNING ENABLED HISTORY MATCHING OF SUBSURFACE PROPERTIES

(71) Applicant: Saudi Arabian Oil Company, Dhahran (SA)

(72) Inventor: Uchenna Odi, Houston, TX (US)

(21) Appl. No.: 18/654,792

(22) Filed: May 3, 2024

(51) Int. Cl. E21B 43/26; G01V 20/00

(52) U.S. Cl. CPC E21B 43/26; G01V 20/00; E21B 2200/20; E21B 2200/22

(57) ABSTRACT

Methods and systems are configured for obtain reservoir data representing one or more features of a reservoir. The reservoir data include a set of values that satisfy a probability distribution associated with that feature. The process includes performing a geological simulation of hydraulic fracturing in the reservoir, the geological simulation generating a production estimate for a well based on the reservoir data, the production estimate associated with the one or more features; generating training data using the production estimate associated with the one or more features. The process includes training, using the training data, a machine learning model to predict a fracture half-length value of the reservoir, the fracture half-length value corresponding to the hydraulic fracturing represented by the training data. The process includes determining, based on the training, a history-matched value for the fracture half-length of the reservoir.

### TECHNICAL FIELD

The present disclosure applies to techniques for characterizing oil and gas well reservoirs. Specifically, the present disclosure relates to characterizing subsurface properties of hydraulically fractured wells.

### BACKGROUND

Technology developments in horizontal drilling and multistage hydraulic fracturing have played an important role in shale gas recovery such as deep and tight gas recovery. Drilling multiple horizontal wells from a pad has increasingly become a common approach in unconventional resource development. Drilling multiple horizontal wells can reduce drilling costs, shorten drilling times, and reduce negative impacts on land and the environment. The combination of horizontal drilling and hydraulic fracturing can significantly increase the production of reservoirs.

### SUMMARY

The present disclosure describes techniques that can be used for horizontal drilling and multistage hydraulic fracturing. A data processing system is configured to predict fracturing results (fracture half-lengths) based on subsurface properties of a reservoir. A model is generated using a transfer learning process in which subsurface data are semi-randomly generated. A fracturing simulation model is applied to the sampled data, and the output fractures are related to the subsurface parameters for training a machine learning model.

The fracture half-length is a subsurface property that can be relatively difficult to determine from a hydraulic fracturing operation. Fracture half-length includes a distance from the well to the tip of the fracture. The fracture half-length depends on the size of the fracture treatment and varies from a few feet to a few hundred feet. A longer fracture half-length can correlate to greater production for a horizontal well. For example, for a well with injection (e.g., CO2 injection), a longer fracture has greater contact area with a reservoir in the subsurface and enables the CO2 to diffuse in a larger portion of the reservoir, resulting in a greater hydrocarbon recovery factor. The data processing system can recommend a well location or control well fracturing based on the determined fracture half-length for a region of a subsurface.

The data processing system is configured to perform the following process. The data processing system is configured to generate sensitivities using sampling (e.g., Monte Carlo sampling) related to hydraulic fracturing in shale reservoirs. The data processing system is configured to execute a simulator for each hydraulic fracturing sensitivity in a hydraulic fracturing simulator. The data processing system is configured to store the simulation results as a central data set used for machine learning training. This data set serves as the source domain for transfer learning described previously. The data processing system is configured to generate a machine learning model for predicting fracture half-length for a subsurface region using the generated hydraulic fracturing sensitivities as inputs and the corresponding half fracture length as a target parameter. This generalized step serves as the source task. The data processing system is configured to apply the machine learning model output including fracture half-length predictions across target domain.

The data processing system described herein is configured to overcome technical limitations of determining the fracture half-length in subsurface regions. Determining fracture half-length after a hydraulic fracturing task can be difficult and can require several history matching iterations in a finite difference simulator. It is challenging to generate these estimations because there are limited available data for production and subsurface properties hydraulic fracturing of unconventional shales. The many complexities of the subsurface can result in a band of uncertainty in subsurface properties. The uncertainty of subsurface properties can then result in uncertainties in production estimates. These uncertainties are compounded due to the sparsity of hydraulic fracturing data for an area of interest. Additionally, in older fields, existing wells can be adversely affected by nearby newer wells which can add another layer of uncertainty.

The one or more embodiments described in this specification can enable one or more of the following advantages. The data processing system is configured to generate predictions of fracture half-lengths for unconventional shales for which fracturing data are limited. The data processing system can overcome the lack of available fracture data for training machine learning models for prediction of the fracture half-length using the transfer learning process described previously. The data processing system can mitigate the uncertainty of the hydraulic fracturing process by using a reservoir simulation to model the wide band of possible scenarios that can be achieved in hydraulic fracturing. The resulting data generated from this sensitivity analysis can be used to create a proxy model using machine learning techniques. These proxy models can then be applied to actual hydraulic fractured production histories to history match subsurface properties. The result of the history matching process can result in approximate production forecasting of hydraulic fracturing performance and the simultaneous determination of subsurface properties that reflect the complex reality of hydraulic fracturing.

The data processing system can use the predicted fracture half-lengths for a number of applications. For example, decisions on where to drill a well can be made based on the predicted fracture half-lengths. The cluster or fracture spacing can be optimized to maximize production but minimize drilling and fracturing costs. Cluster spacing represents a distance between perforations per lateral length during hydraulic fracturing. The spacing between the clusters can vary from 25 feet (˜7.62 meters) up to 100 feet (˜30.5 meters). The data processing system can otherwise be configured to control fracturing or drilling of wells based on the predicted fracture half-lengths. The half fracture system can also be utilized to anticipate optimal well spacing that will minimize the impact of parent-child fracture interference effects.

The one or more foregoing advantages can be enabled by one or more of the following embodiments.

In an aspect, a process for configuring a well for hydraulic fracturing includes the following operations. The process includes obtaining reservoir data representing one or more features of a reservoir, the reservoir data comprising, for each of the one or more features, a set of values that satisfy a probability distribution associated with that feature. The process includes performing a geological simulation of hydraulic fracturing in the reservoir, the geological simulation generating a production estimate for a well based on the reservoir data, the production estimate associated with the one or more features. The process includes generating training data using the production estimate associated with the one or more features. The process includes training, using the training data, a machine learning model to predict a fracture half-length value of the reservoir, the fracture half-length value corresponding to the hydraulic fracturing represented by the training data. The process includes determining, based on the training, a history-matched value for the fracture half-length of the reservoir.

In some implementations, the process includes, based on the a history-matched value for the fracture half-length, determining a cluster spacing in a horizontal well, a stage depth in the horizontal well, or both the cluster spacing and the stage depth in the horizontal well for performing hydraulic fracturing.

In some implementations, the process includes fracturing the horizontal well based on the cluster spacing in the horizontal well, the stage depth in the horizontal well, or both the cluster spacing and the stage depth in the horizontal well.

In some implementations, the features include one or more of a gas production rate, a depth of a well, a producing gas-oil ratio, a reservoir temperature, a tubing diameter, a gas gravity, a bottomhole pressure of a well, a reservoir pressure, a permeability of the reservoir, a porosity of the reservoir, a number of fractures associated with a well, a lateral length of a well, and a formation thickness.

In some implementations, the reservoir data comprise a Monte Carlo sampling of values for each of the one or more features, the values satisfying the probability distribution associated with each feature.

In some implementations, the process includes determining that a mismatch exists between a production history of the reservoir and an output of the geological simulation of hydraulic fracturing in the reservoir. In some implementations, the process includes updating the geological simulation to change an inputted fracture half-length value of the reservoir data.

In some implementations, the machine learning model is further trained to predict the fracture half-length of the reservoir based on a porosity of the reservoir, a permeability of the reservoir, a net pay of the reservoir, a relative permeability of the reservoir, and a fracture conductivity of the reservoir.

In an aspect, a system is for configuring a well for hydraulic fracturing. The system includes at least one processor and a memory storing instructions, that, when executed by the at least one processor, cause the at least one processor to perform operations of the processes described herein.

In an aspect, one or more non-transitory computer readable media store instructions for configuring a well for hydraulic fracturing. The instructions, when executed by at least one processor, are configured to cause the at least one processor to perform operations of the processes described herein.

The details of one or more embodiments are set forth in the accompanying drawings and the description below. Other features and advantages will be apparent from the description and drawings, and from the claims.

### BRIEF DESCRIPTION OF THE DRAWINGS

FIG. 1 shows an example schematic of a well in a subterranean formation.

FIG. 2A shows an example schematic of a well.

FIG. 2B shows an example diagram of a control center.

FIG. 2C shows an example process for transfer learning enabled history matching of subsurface properties.

FIG. 3 shows a graph representing example cross validation results for half fracture length machine learning prediction.

FIG. 4 shows a chart representing example data for a relative feature of importance for half fracture length machine learning prediction.

FIGS. 5A-5B each show a graph representing an example of history matched average gas production.

FIG. 6 shows a chart representing example data for history matched cumulative gas production.

FIG. 7 illustrates hydrocarbon production operations.

FIG. 8 is a diagram of an example computing system.

Like reference numbers and designations in the various drawings indicate like elements.

### DETAILED DESCRIPTION

This disclosure describes systems and methods to predict fracturing results (fracture half-lengths) based on subsurface properties of a reservoir. A data processing system is configured to determine the half-fracture length of a subsurface region based on application of transfer learning in conjunction with hydraulic fracturing simulation and probabilistic sampling. Specifically, the data processing system is configured to apply a transfer learning process to half-fracture length prediction involved utilizing a hydraulic fracturing simulator, Monte Carlo Sampling, and machine learning models. Transfer learning includes training machine learning models using uncertainty/sensitivity analysis from simulation data and applying these trained machine learning models to a different task, which includes training these models on data generated from actual hydraulic fracturing. The machine learning models are therefore trained with multiple objective functions. The machine learning models can predict, for a subsurface region, values for a fracture half-length property. The data processing system can use the predicted fracture half-lengths for a number of applications. For example, decisions on where to drill a well can be made based on the predicted fracture half-lengths. The cluster or fracture spacing can be optimized to maximize production but minimize drilling and fracturing costs.

As described herein, the data processing system includes one or more simulators configured to generate training data for the one or more machine learning models. The data processing system can mitigate the uncertainty of the hydraulic fracturing process by using a reservoir simulation to model the wide band of possible scenarios that can be achieved in hydraulic fracturing. The resulting data generated from this sensitivity analysis can be used to create a proxy model using machine learning techniques. These proxy models can then be applied to actual hydraulic fractured production histories to history match subsurface properties. The result of the history matching process can result in approximate production forecasting of hydraulic fracturing performance and the simultaneous determination of subsurface properties that reflect the complex reality of hydraulic fracturing.

One or more simulators of the data processing system are used to generate the fracture lengths. The one or more simulators use first principal physics assumptions such as pressure diffusivity, Darcy's Law, and material balance to model fracture half-lengths as a function of several properties such as porosity, permeability, net pay, relative permeability, fracture conductivity, and so forth. A simulator then generates a production estimate of gas, oil, and water through time.

The data processing system performs a process to iteratively estimate fracture half-length from simulation. The data processing system executes a simulator to model gas, oil, and water production. The data processing system compares the predicted production to a measured production history of a reservoir included in the subsurface region for which the fracture half-length values are being predicted. If there is a mismatch between the production history of the field and the simulation model, the data processing system updates the simulation model to change an inputted fracture half-length value. The data processing system can therefore include an iterative process of changing half fracture length. The process can be repeated until there is no longer a mismatch between production history and simulated production history. This process is called reservoir simulation enabled history matching.

The data processing system includes one or more machine learning models that use one or more realizations of the simulator as a training set. The data processing system uses the training train a machine learning model to predict fracture half-length values for a subsurface. The data processing system uses the trained machine learning model estimate or predict fracture half-length values based on a production history (e.g., oil, gas, and water production) for the subsurface region. The machine learning models of the data processing system can further predict fracture half-length based on geo-mechanical properties of the subsurface including porosity, permeability, net pay, relative permeability, and fracture conductivity. The data processing system uses the machine learning and transfer learning process to enable utilization of several realizations of the machine learning model to create a function to estimate half fracture length. As an example of this, the machine learning model can be generated and applied to areas with unknown measurement of fracture half length. If there is uncertainty in the inputs of the machine learning model, transfer learning can be applied across the wide band of uncertainty such that several realizations of the machine learning model are deployed for each realization of uncertainty. The data processing system applies the generated function to production history data associated with the subsurface region to generate an estimate of the fracture half-length of the reservoir (e.g., the field).

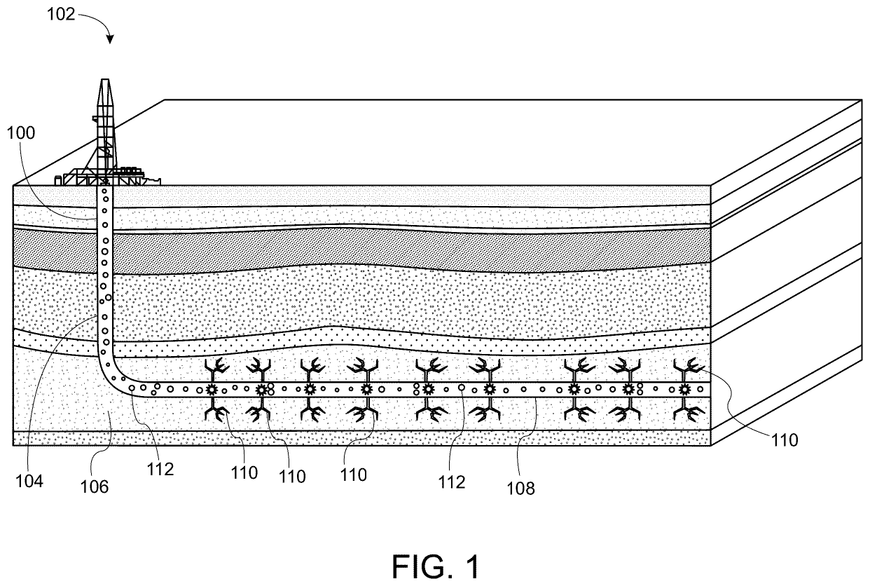

FIG. 1 shows an example schematic of a well 100 in a subterranean formation 102. In this example, the well 100 has a vertical portion 104 extending vertically from the surface of the subterranean formation to a target reservoir formation 106 at a predetermined depth. The well 100 then turns and has a horizontal portion 108 extending for a predetermined length through the target reservoir formation 106.

Hydraulic fracturing is a well completion operation used to crack a target reservoir formation 106 via injection of high-pressure water to prepare the well 100 for production and improve the flow of hydrocarbons to the wellbore, for example, in low permeability formations. Fractures 110 are created by cracking or perforating the rocks in the target reservoir formation 106 along the horizontal portion 108 of the well 100. High-pressure water can then be pumped into the fractures 110 to enlarge the fracture width and extent. Once a target reservoir formation 106 is fractured, proppants 112 are pumped into these fractures 106 to keep them open after the hydraulic pressure is reduced.

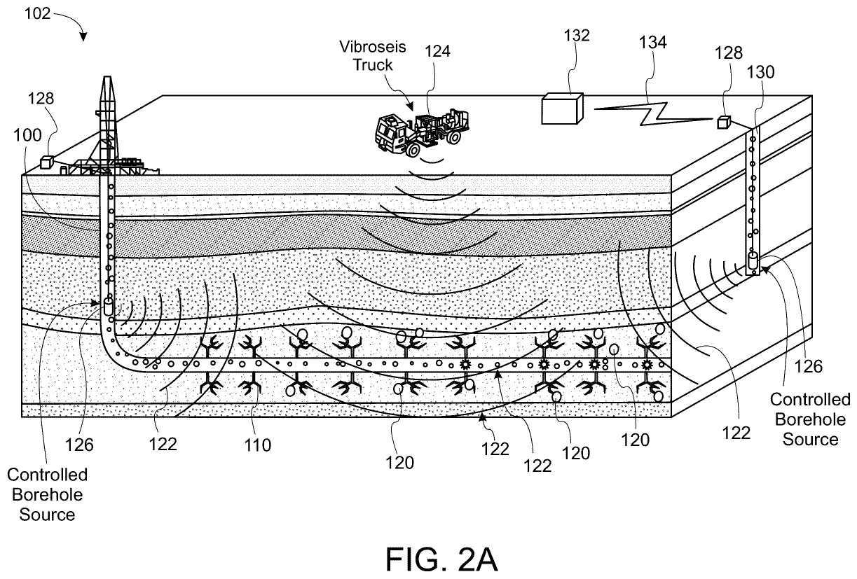

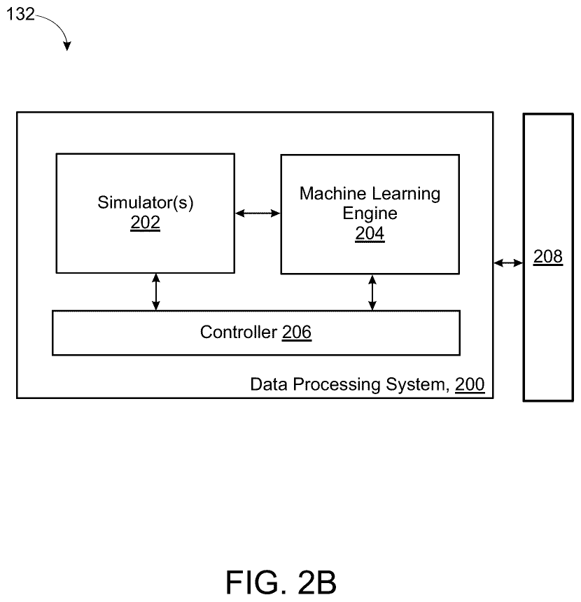

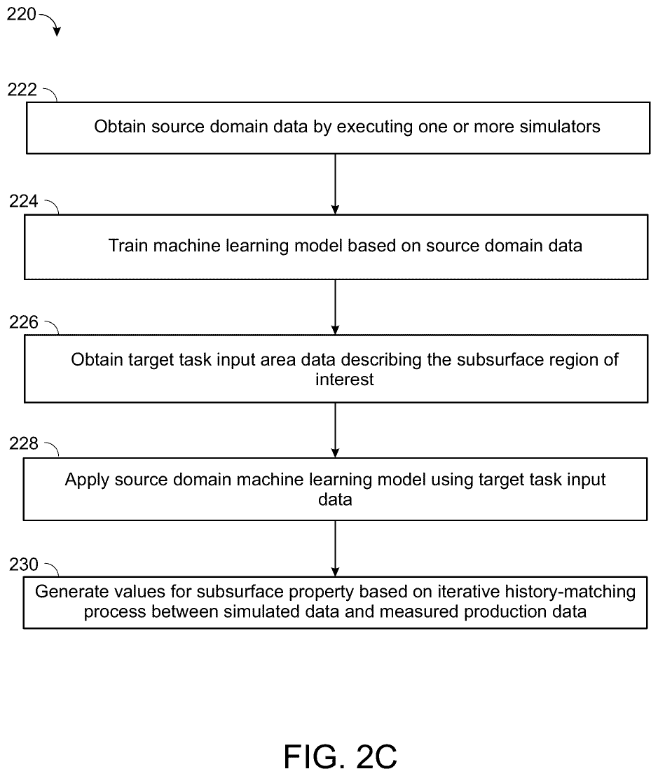

FIG. 2A shows an example schematic of a well 100 where micrometer to millimeter sized in-situ sensors 120 have been pumped into the well 100 at the same time as the proppants 112 during a hydraulic fracturing completion. The in-situ sensors 120 enter the fractures 110 alongside the proppants 112. The in-situ sensors 120 aid in monitoring the facture extent and direction. The in-situ sensors are programmed to activate after sensing a pre-defined vibration pattern 122. In this example, the in-situ sensors 120 are activated by sending a pre-designed vibration pattern 122 into the subterranean formation 102. The pre-designed vibration pattern 122 can be generated on the surface by, for example, a vibroseis truck 124. In some implementations, the pre-designed vibration pattern 122 is generated from a controlled borehole source 126 that is connected to a control station 128. The controlled borehole source 126 is located in the same well 100 as the fracturing treatment. In other implementations, the controlled borehole source 126 is located in a nearby well 130 or in a lateral. In some implementations, the pre-designed vibration pattern 122 is provided by a combination of one or more of surface sources, such as vibroseis trucks 124, and controlled borehole sources 126. In some implementations, a control center 132 is configured to communicate with one or more of the control stations 128 over a network 134.

The control center 132 is shown in FIG. 2B. The control center 132 is configured to send control signals to drilling or hydraulic fracturing equipment in the reservoir in response to computing the prediction data as previously described. The control center 132 is configured to receive geomechanics data from one or more of the wells in the reservoir. A data processing system 200 of the control center 132 is configured to generate prediction data representing predictions of fracture half-lengths based on subsurface properties of a reservoir including the well 100. The control center 132 can be located remote from the reservoir that includes the well 100. The control center can receive hydraulic fracturing data associated with the well 100 for making the predictions of fracture half-lengths.

The data processing system 200 is configured to use one or more simulators 202 and machine learning models 204 to generate the predictions of the fracture half-length values for the reservoir including the well 100. The data processing system 200 can execute process 220 to generate the predictions.

FIG. 2C shows an example process 220 for transfer learning enabled history matching of subsurface properties. The process 220 is configured to determine the half-fracture length of a subsurface region based on application of transfer learning in conjunction with hydraulic fracturing simulation and probabilistic sampling.

As described herein, the data processing system executes one or more simulators 202 configured to generate training data for the one or more machine learning engine 204. The data processing system can mitigate the uncertainty of the hydraulic fracturing process by using a reservoir simulator 202 to model the wide band of possible scenarios that can be achieved in hydraulic fracturing.

The data processing system is configured to obtain (222) source domain data. The source domain data includes reservoir data for a particular reservoir. The data processing system 200 obtains the source domain data by generating sensitivities data using Monte Carlo sampling related to hydraulic fracturing in shale reservoirs. The data processing system generates performs a sensitivity analysis to assess which geological and operational parameters have greater impacts the geometry of a single fracture in the subterranean formation 102. An example of source domain data from sensitivity analysis is shown in Table 1.

TABLE 1
Hydraulic Fracturing Sensitivity Parameter Ranges for Monte Carlo Sampling

| Parameter | Minimum | Maximum | Probability Distribution |
|---|---|---|---|
| Fracture Half Length, feet (ft) | 100 | 600 | Uniform |
| Lateral Well Length, ft | 1,000 | 12,000 | Triangular |
| Number of Fractures | 5 | 600 | Uniform |
| Permeability, millidarcy (mD) | .0001 | .1 | Lognormal |
| Porosity | .01 | .13 | Uniform |
| Formation Thickness, ft | 10 | 1,000 | Uniform |
| Gas Gravity | 0.55 | 1.6 | Uniform |
| Surface Pressure, pounds per | 300 | 1,000 | Uniform |
| square foot absolute (psia) | | | |
| Reservoir Pressure, psia | 5,000 | 10,000 | Uniform |
| Reservoir Temperature, degrees | 200 | 300 | Uniform |
| Fahrenheit (° F.) | | | |
| Producing oil (condensate) gas | 10 | 313 | Uniform |
| ratio, production gas-oil ratio in | | | |
| stock tank barrels per million | | | |
| standard cubic feet (STB/MMSCF) | | | |
| Tubing Diameter, in | 2.5 | 5 | Uniform |
| Formation Depth, ft | 1,000 | 15,000 | Uniform |

The selected ranges were obtained from based on examples of observed operational data, such as from the Eagle Ford unconventional basin located in North America.

The data processing system 200 executes the one or more simulators 202 to generate fracture lengths data. The one or more simulators use first principal physics assumptions such as pressure diffusivity, Darcy's Law, and material balance to model fracture half lengths as a function of several properties such as porosity, permeability, net pay, relative permeability, fracture conductivity, and so forth. A simulator then generates a production estimate of gas, oil, and water through time.

The execution of the simulators includes running each hydraulic fracturing sensitivity in a hydraulic fracturing simulator and storing the result as part of a central data set used for machine learning training. This data set serves as the source domain for transfer learning.

The simulator generates the output data by running each set of realizations and then outputting the resulting well rates (e.g., for gas, water, and oil). In an example, the simulator utilized was a finite difference based simulator that modeled the hydraulic fracturing process. The fracturing simulator is based on first principals such as physics, material balance, and energy balance. The fracturing simulator can take some considerable time to run a single model. The machine learning model is based on data trained from the fracturing simulator results. Once trained, the machine learning model can run instantaneously because it is a deployed model that does not need to be simulated. The machine learning model uses the simulator and existing production data to estimate the half fracture length.

The data processing system 200 uses the resulting data generated from the sensitivity analysis to train (224) a machine learning model. The data processing system 200 generates a machine learning model configured to predict a fracture half-length using the generated hydraulic fracturing sensitivities as inputs and the corresponding fracture half-length as the target parameter. An example of training data is shown in Table 2. A gradient boost machine learning model was utilized at this step. The sensitivities across the training data are used to generate the multiple realizations of the input data. These realizations are simulated in the simulator and the result production data is generated for each set of realizations. Table 2 represents the statistical summary of the uncertainty in the input data and the resulting production data that generated after running each Monte Carlo realization in the simulator.

TABLE 2
Statistical Ranges for Hydraulic Fracturing Monte Carlo Sampling and Simulation

| Parameter | Mean | Standard Deviation | Minimum | Maximum |
|---|---|---|---|---|
| Gas Production Rate, thousand | 20.7 | 21.4 | 0.025 | 109 |
| standard cubic feet per day | | | | |
| (MSCF/Day) | | | | |
| Fracture Half Length, feet (ft) | 345 | 143 | 100 | 600 |
| Lateral Length, ft | 5664 | 2188 | 1128 | 11829 |
| Number of Fractures | 107 | 57 | 5 | 203 |
| Permeability, millidarcy (mD) | 0.00476 | 0.00423 | 0.000256 | 0.0363 |
| Porosity | 0.0654 | 0.0345 | 0.0100 | 0.130 |
| Formation Thickness, ft | 473 | 291 | 11 | 1000 |
| Gas Gravity | 1.08 | 0.297 | 0.551 | 1.60 |
| Bottomhole Pressure, pounds | 877 | 301 | 337 | 1916 |
| per square foot absolute (psia) | | | | |
| Reservoir Pressure, psia | 7496 | 1435 | 5004 | 9997 |
| Reservoir Temperature, | 250 | 28.4 | 200 | 300 |
| degrees Fahrenheit (° F.) | | | | |
| Producing Oil Gas Ratio, | 159 | 86.8 | 10.1 | 313 |
| production gas-oil ratio in stock | | | | |
| tank barrels per million standard | | | | |
| cubic feet (STB/MMSCF) | | | | |
| Tubing Diameter, inches (in) | 3.79 | 0.72 | 2.50 | 5.00 |
| Depth, ft | 7960 | 4084 | 1008 | 14995 |

The data processing system 200 is configured to obtain (226) obtain target task input area data describing the subsurface region of interest. The target task input area data includes data from hydraulic fracturing in the subterranean formation 102 (such as at well 100). These data include production history data from wells such as well 100 and data describing the formation itself. In this example, the Eagle Ford reservoir is used as the target domain. Eagle Ford example includes of more than 20,000 wells with varying production history and reservoir properties. These example data are shown in Table 3.

TABLE 3
Statistical Summary of an example target domain (Eagle Ford).

| | | Standard | | |
|---|---|---|---|---|
| Parameter | Mean | Deviation | Minimum | Maximum |
| Gas Production Rate, thousand | 343 | 728 | 0 | 46094 |
| standard cubic feet per day | | | | |
| (MSCF/Day) | | | | |
| Depth, feet (ft) | 9997 | 2006 | 4038 | 14000 |
| Formation Thickness, ft | 145.4 | 37.8 | 48.6 | 291 |
| Porosity | 0.134 | 0.0195 | 0.042 | 0.240 |
| Lateral Length, ft | 5485 | 1475 | 115 | 20564 |
| Reservoir Pressure, pounds per | 6013 | 1203 | 2437 | 8415 |
| square inch absolute (psia) | | | | |
| Reservoir Temperature, Degrees | 260 | 40.1 | 141 | 340 |
| Fahrenheit (° F.) | | | | |
| Producing Oil Gas Ratio, | 97902 | 11658994 | 0 | 1398100820 |
| STB/MMSCF | | | | |
| Gas Gravity | 0.822 | 0.052 | 0.490 | 1.40 |
| Permeability, millidarcy (mD) | 0.00000550 | 0.00000006 | 0.00000522 | 0.00000583 |
| Bottomhole Pressure, psia | 1000 | 0 | 1000 | 1000 |
| Tubing Diameter, inches (in) | 4 | 0 | 4 | 4 |
| Number of Fractures | 96.0 | 2.30 | 28 | 168 |

The data processing system 200 is configured to apply (228) the trained machine learning model to generate a fracture half-length prediction across the target domain. As previously described, the data processing system 200 can apply the machine learning model to actual hydraulic fractured production histories data (e.g., from Table 3) to history match subsurface properties. The result of the history matching process can result in approximate production forecasting of hydraulic fracturing performance and the simultaneous determination of subsurface properties that reflect results of hydraulic fracturing.

The one or more machine learning models use one or more realizations of the simulator as a training set, as previously described. The data processing system uses the trained machine learning model estimate or predict fracture half-length values based on a production history (e.g., oil, gas, and water production) for the subsurface region. The machine learning models of the data processing system can further predict fracture half-length based on geo-mechanical properties of the subsurface including porosity, permeability, net pay, relative permeability, and fracture conductivity.

The data processing system generates (230) values for subsurface property based on iterative history-matching process between simulated data and measured production data. The data processing system uses the machine learning and transfer learning process to enable utilization of several realizations of the machine learning model to create a function to estimate half fracture length. As an example of this function, the machine learning model can be generated and applied to areas with unknown measurement of fracture half length. If there is uncertainty in the inputs of the machine learning model, transfer learning can be applied across the wide band of uncertainty such that several realizations of the machine learning model are deployed for each realization of uncertainty.

The data processing system iteratively estimates fracture half-length from the simulation data. The data processing system compares the predicted production to a measured production history of a reservoir included in the subsurface region for which the fracture half-length values are being predicted. If there is a mismatch between the production history of the field and the simulation model, the data processing system updates the simulation model to change an inputted fracture half-length value. The data processing system can therefore include an iterative process of changing half fracture length. The generation of values at step 230 is repeated until there is no longer a mismatch between production history and simulated production history

The data processing system 200 generates, for performing hydraulic fracturing, predicted values of fracture half-lengths for different locations for wells (such as well 100) in a subsurface region (such as subterranean formation 102 of FIG. 1). In an example, the controller 132 is configured to select clusters depth and stage depth in which the well is expected to produce the highest early production. Specifically, the controller 206 of the data processing system 200 can output one or more control signals for controlling clusters depths and stage depths for hydraulic fracturing. In some implementations, the controller 206 can output a visualization showing the selected locations in the subterranean formation 102 for drilling or fracturing wells. In some implementations, the control signals can be transmitted to a remote system through a communication interface 208.

The data processing system 200 is configured to perform a qualitative ranking of depths in the well 100 to place clustering and stage operations and estimate corresponding expected early stage production based on the selected depths. In some implementations, the data processing system 200 is configured for planning and completion design including depth selection.

In some implementations, the data processing system 200 is configured to flag the best intervals to perform hydraulic fracturing. The factors for the best intervals can include stress anisotropy, rock mechanics anisotropy and near wellbore anisotropy, as previously described. The best interval with the best geomechanics properties (including the predicted fracture half-length) correlated with optimal production is selected or flagged by the data processing system 200. The data processing system 200 is configured to perform calibration based on previously identified best intervals. The data processing system 200 uses existing data to generate the predictions for a planning phase. The predictions include a best depth to place clusters and stages.

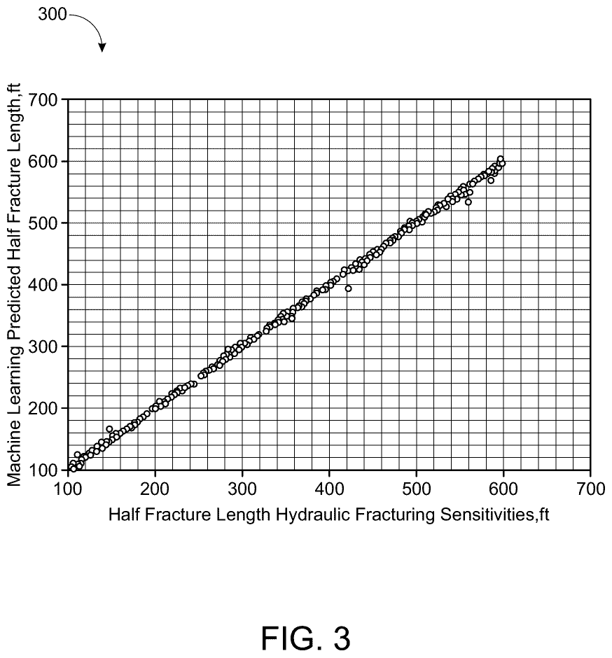

FIG. 3 shows a graph 300 representing example cross validation results for half fracture length machine learning prediction. The results in graph 300 show fracture half-length values vs. predicted half-fracture lengths for a given domain. The results of graph 300 are generated based on Monte Carlo sampling of data from the domain, as described previously. Graph 300 shows a close correlation between predicted fracture half-lengths from the machine learning engine 204 and the measured fracture half-lengths from hydraulic fracturing sensitivities data.

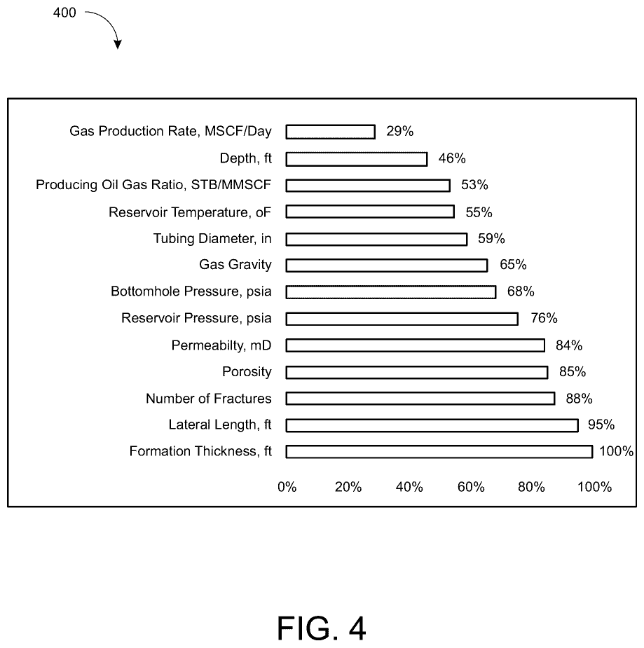

FIG. 4 shows a chart 400 representing example data for a relative feature of importance for half fracture length machine learning prediction. Each of the features of chart 400 is a part of the analysis. The features include gas production rate in units of a thousand standard cubic feet per day (MSCF per day). The features include a depth of the wells (e.g., well 100) in feet. The features include a production gas-oil ratio in stock tank barrels per million standard cubic feet (STB/MMSCF). The features include a reservoir temperature in degrees Fahrenheit. The features include a tubing diameter of the well (e.g., well 100) in inches. The features include a gas gravity. The features include a bottomhole pressure in pounds per square inch absolute (PSIA). The features include a permeability. The features include a porosity. The features include a number of the fractures generated for a well (e.g., well 100). The features include a lateral length of the well (e.g., well 100) in feet. The features include a formation thickness in feet. As shown in chart 400, the formation thickness is the most important feature for predicting fracture half-length values. The feature of gas production rate is the least important feature for predicting fracture half-length values for a well.

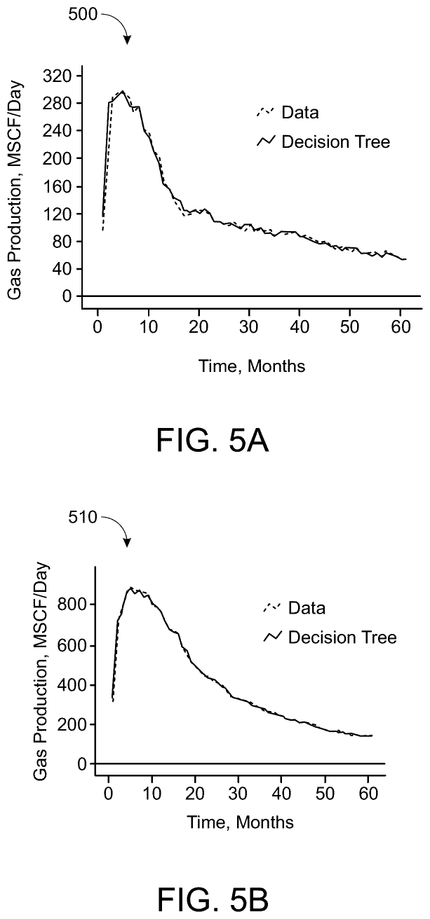

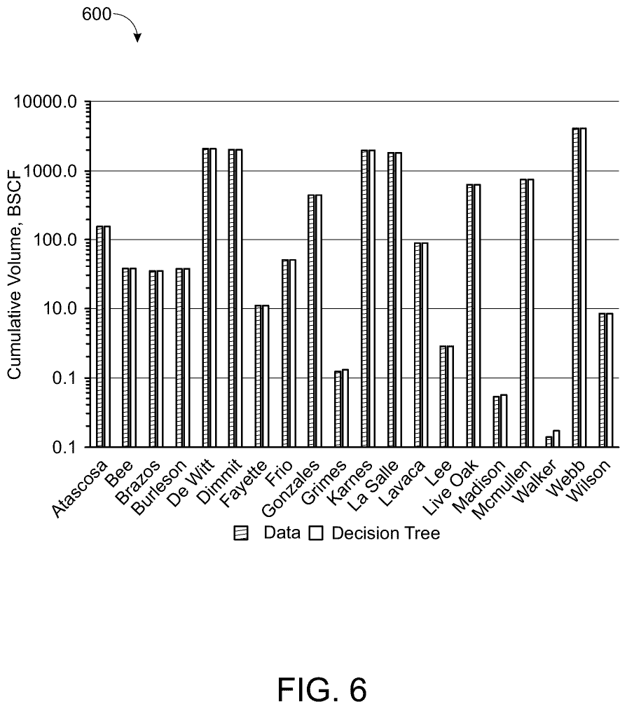

FIG. 5A shows a graph 500 representing an example of history matched average gas production for a first reservoir area. FIG. 5B shows a graph 510 representing an example of history matched average gas production for a second reservoir area. FIG. 6 shows a chart 600 representing example data for history matched cumulative gas production. The history matched data represents the machine learning model that was deployed using inputs which included the previously predicted half fracture length. FIGS. 5A-6 illustrate the accuracy of the estimated half fracture length because the utilization of the estimate resulted in accurate time average production estimates and cumulative volume estimates across several counties in the Eagle Ford basin. The decision tree was generated by using the estimated half fracture length, reservoir properties, and production data. These outputs were matched because of the improved estimate of half fracture length made possible by the transfer learning process.

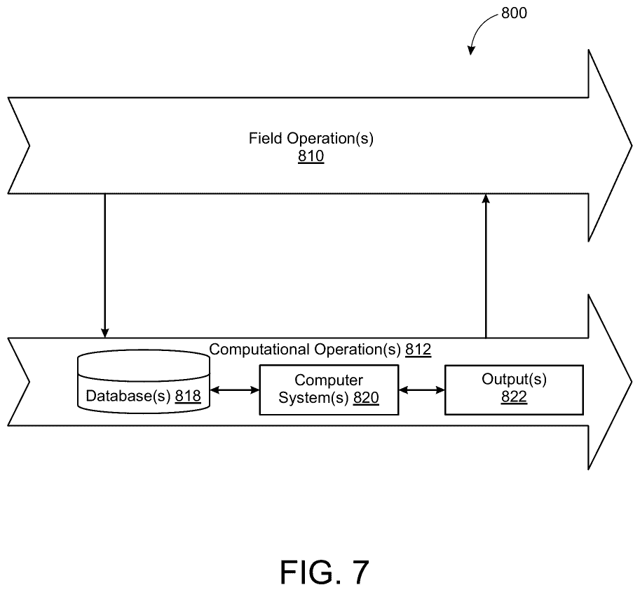

FIG. 7 illustrates hydrocarbon production operations 800 that include both one or more field operations 810 and one or more computational operations 812, which exchange information and control exploration to produce hydrocarbons. In some implementations, outputs of techniques of the present disclosure (e.g., the method 300) can be performed before, during, or in combination with the hydrocarbon production operations 800, specifically, for example, either as field operations 810 or computational operations 812, or both. For example, the processes 300, 320 collect data during field operations, processes the data in computational operations, and can determine locations to perform additional field operations.

Examples of field operations 810 include forming/drilling a wellbore, hydraulic fracturing, producing through the wellbore, injecting fluids (such as water) through the wellbore, to name a few. In some implementations, methods of the present disclosure can trigger or control the field operations 810. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 810 and responsively triggering the field operations 810 including, for example, generating plans and signals that provide feedback to and control physical components of the field operations 810. Alternatively, or in addition, the field operations 810 can trigger the methods of the present disclosure. For example, implementing physical components (including, for example, hardware, such as sensors) deployed in the field operations 810 can generate plans and signals that can be provided as input or feedback (or both) to the methods of the present disclosure.

Examples of computational operations 812 include one or more computer systems 820 that include one or more processors and computer-readable media (e.g., non-transitory computer-readable media) operatively coupled to the one or more processors to execute computer operations to perform the methods of the present disclosure. The computational operations 812 can be implemented using one or more databases 818, which store data received from the field operations 810 and/or generated internally within the computational operations 812 (e.g., by implementing the methods of the present disclosure) or both. For example, the one or more computer systems 820 process inputs from the field operations 810 to assess conditions in the physical world, the outputs of which are stored in the databases 818. For example, seismic sensors of the field operations 810 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 812 where they are stored in the databases 818 and analyzed by the one or more computer systems 820.

In some implementations, one or more outputs 822 generated by the one or more computer systems 820 can be provided as feedback/input to the field operations 810 (either as direct input or stored in the databases 818). The field operations 810 can use the feedback/input to control physical components used to perform the field operations 810 in the real world.

For example, the computational operations 812 can process the seismic data to generate three-dimensional (3D) maps of the subsurface formation. The computational operations 812 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 812 to process new information about the formation and control the drilling to adjust to the observed conditions in real-time.

The one or more computer systems 820 can update the 3D maps of the subsurface formation as information from one exploration well is received and the computational operations 812 can adjust the location of the next exploration well based on the updated 3D maps. Similarly, the data received from production operations can be used by the computational operations 812 to control components of the production operations. For example, production well and pipeline data can be analyzed to predict slugging in pipelines leading to a refinery and the computational operations 812 can control machine operated valves upstream of the refinery to reduce the likelihood of plant disruptions that run the risk of taking the plant offline.

In some implementations of the computational operations 812, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 8 s. While the requested data need not be displayed (or initiated for display) instantaneously, it is displayed (or initiated for display) without any intentional delay, accounting for processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are in different countries or other jurisdictions.

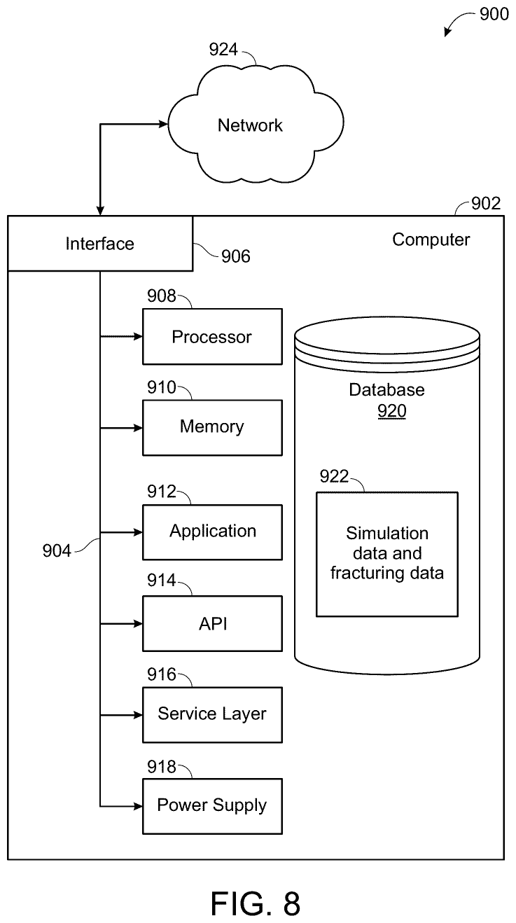

FIG. 8 is a block diagram of an example computer system 900 used to provide computational functionalities associated with described algorithms, methods, functions, processes, flows, and procedures described in the present disclosure, according to some implementations of the present disclosure. The illustrated computer 902 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 902 can include input devices such as keypads, keyboards, and touch screens that can accept user information. Also, the computer 902 can include output devices that can convey information associated with the operation of the computer 902. The information can include digital data, visual data, audio information, or a combination of information. The information can be presented in a graphical user interface (UI) (or GUI).

The computer 902 can serve in a role as a client, a network component, a server, a database, a persistency, or components of a computer system for performing the subject matter described in the present disclosure. The illustrated computer 902 is communicably coupled with a network 924. In some implementations, one or more components of the computer 902 can be configured to operate within different environments, including cloud-computing-based environments, local environments, global environments, and combinations of environments.

At a high level, the computer 902 is an electronic computing device operable to receive, transmit, process, store, and manage data and information associated with the described subject matter. According to some implementations, the computer 902 can also include, or be communicably coupled with, an application server, an email server, a web server, a caching server, a streaming data server, or a combination of servers.

The computer 902 can receive requests over network 924 from a client application (for example, executing on another computer 902). The computer 902 can respond to the received requests by processing the received requests using software applications. Requests can also be sent to the computer 902 from internal users (for example, from a command console), external (or third) parties, automated applications, entities, individuals, systems, and computers.

Each of the components of the computer 902 can communicate using a system bus 904. In some implementations, any or all of the components of the computer 902, including hardware or software components, can interface with each other or the interface 906 (or a combination of both), over the system bus 904. Interfaces can use an application programming interface (API) 914, a service layer 916, or a combination of the API 914 and service layer 916. The API 914 can include specifications for routines, data structures, and object classes. The API 914 can be either computer-language independent or dependent. The API 914 can refer to a complete interface, a single function, or a set of APIs.

The service layer 916 can provide software services to the computer 902 and other components (whether illustrated or not) that are communicably coupled to the computer 902. The functionality of the computer 902 can be accessible for all service consumers using this service layer. Software services, such as those provided by the service layer 916, can provide reusable, defined functionalities through a defined interface. For example, the interface can be software written in JAVA, C++, or a language providing data in extensible markup language (XML) format. While illustrated as an integrated component of the computer 902, in alternative implementations, the API 914 or the service layer 916 can be stand-alone components in relation to other components of the computer 902 and other components communicably coupled to the computer 902. Moreover, any or all parts of the API 914 or the service layer 916 can be implemented as child or sub-modules of another software module, enterprise application, or hardware module without departing from the scope of the present disclosure.

The computer 902 includes an interface 906. Although illustrated as a single interface 906 in FIG. 8, two or more interfaces 906 can be used according to implementations of the computer 902 and the described functionality. The interface 906 can be used by the computer 902 for communicating with other systems that are connected to the network 924 (whether illustrated or not) in a distributed environment. Generally, the interface 906 can include, or be implemented using, logic encoded in software or hardware (or a combination of software and hardware) operable to communicate with the network 924. More specifically, the interface 906 can include software supporting one or more communication protocols associated with communications. As such, the network 924 or the interface's hardware can be operable to communicate physical signals within and outside of the illustrated computer 902.

The computer 902 includes a processor 908. Although illustrated as a single processor 908 in FIG. 8, two or more processors 908 can be used according to implementations of the computer 902 and the described functionality. Generally, the processor 908 can execute instructions and can manipulate data to perform the operations of the computer 902, including operations using algorithms, methods, functions, processes, flows, and procedures as described in the present disclosure.

The computer 902 also includes a database 920 that can hold data (such as simulation and fracturing data 922) for the computer 902 and other components connected to the network 924 (whether illustrated or not). For example, database 920 can be in-memory or a database storing data consistent with the present disclosure. In some implementations, database 920 can be a combination of two or more different database types (for example, hybrid in-memory and conventional databases) according to implementations of the computer 902 and the described functionality. Although illustrated as a single database 920 in FIG. 8, two or more databases (of the same, different, or combination of types) can be used according to implementations of the computer 902 and the described functionality. While database 920 is illustrated as an internal component of the computer 902, in alternative implementations, database 920 can be external to the computer 902.

The computer 902 also includes a memory 910 that can hold data for the computer 902 or a combination of components connected to the network 924 (whether illustrated or not). Memory 910 can store any data consistent with the present disclosure. In some implementations, memory 910 can be a combination of two or more different types of memory (for example, a combination of semiconductor and magnetic storage) according to implementations of the computer 902 and the described functionality. Although illustrated as a single memory 910 in FIG. 8, two or more memories 910 (of the same, different, or combination of types) can be used according to implementations of the computer 902 and the described functionality. While memory 910 is illustrated as an internal component of the computer 902, in alternative implementations, memory 910 can be external to the computer 902.

The application 912 can be an algorithmic software engine providing functionality according to implementations of the computer 902 and the described functionality. For example, application 912 can serve as one or more components, modules, or applications. Further, although illustrated as a single application 912, the application 912 can be implemented as multiple applications 918 on the computer 902. In addition, although illustrated as internal to the computer 902, in alternative implementations, the application 912 can be external to the computer 902.

The computer 902 can also include a power supply 918. The power supply 918 can include a rechargeable or non-rechargeable battery that can be configured to be either user- or non-user-replaceable. In some implementations, the power supply 918 can include power-conversion and management circuits, including recharging, standby, and power management functionalities. In some implementations, the power-supply 918 can include a power plug to allow the computer 902 to be plugged into a wall socket or a power source to, for example, power the computer 902 or recharge a rechargeable battery.

There can be any number of computers 902 associated with, or external to, a computer system including the computer 902, with each computer 902 communicating over network 924. Further, the terms “client,” “user,” and other appropriate terminology can be used interchangeably, as appropriate, without departing from the scope of the present disclosure. Moreover, the present disclosure contemplates that many users can use one computer 902 and one user can use multiple computers 902.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus”, “computer”, and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random-access memory (RAM), read only memory (ROM), phase change memory (PRAM), static random-access memory (SRAM), dynamic random-access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

Several implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Certain features that are described in this specification in the context of separate implementations can also be implemented, in combination, in a single implementation. Conversely, various features that are described in the context of a single implementation can also be implemented in multiple implementations, separately, or in any suitable sub-combination. The separation or integration of various system modules and components in the previously described implementations should not be understood as requiring such separation or integration in all implementations, and the described program components and systems can generally be integrated together in a single product or packaged into multiple products.

Accordingly, the previously described example implementations do not define or constrain the present disclosure. It will be understood that various modifications may be made without departing from the scope of the systems and methods described herein. Accordingly, other embodiments are within the scope of the following claims.

What is claimed is:

1. A method for configuring a well for hydraulic fracturing, the method comprising:
obtaining reservoir data representing one or more features of a reservoir, the reservoir data comprising, for each of the one or more features, a set of values that satisfy a probability distribution associated with that feature;
performing a geological simulation of hydraulic fracturing in the reservoir, the geological simulation generating a production estimate for a well based on the reservoir data, the production estimate associated with the one or more features;
generating training data using the production estimate associated with the one or more features;
training, using the training data, a machine learning model to predict a fracture half-length value of the reservoir, the fracture half-length value corresponding to the hydraulic fracturing represented by the training data; and
determining, based on the training, a history-matched value for the fracture half-length of the reservoir.

2. The method of claim 1, further comprising:
based on the a history-matched value for the fracture half-length, determining a cluster spacing in a horizontal well, a stage depth in the horizontal well, or both the cluster spacing and the stage depth in the horizontal well for performing hydraulic fracturing.

3. The method of claim 2, further comprising fracturing the horizontal well based on the cluster spacing in the horizontal well, the stage depth in the horizontal well, or both the cluster spacing and the stage depth in the horizontal well.

4. The method of claim 1, wherein the features include one or more of a gas production rate, a depth of a well, a producing gas-oil ratio, a reservoir temperature, a tubing diameter, a gas gravity, a bottomhole pressure of a well, a reservoir pressure, a permeability of the reservoir, a porosity of the reservoir, a number of fractures associated with a well, a lateral length of a well, and a formation thickness.

5. The method of claim 1, wherein the reservoir data comprise a Monte Carlo sampling of values for each of the one or more features, the values satisfying the probability distribution associated with each feature.

6. The method of claim 1, further comprising:
determining that a mismatch exists between a production history of the reservoir and an output of the geological simulation of hydraulic fracturing in the reservoir; and
updating the geological simulation to change an inputted fracture half-length value of the reservoir data.

7. The method of claim 1, wherein the machine learning model is further trained to predict the fracture half-length of the reservoir based on a porosity of the reservoir, a permeability of the reservoir, a net pay of the reservoir, a relative permeability of the reservoir, and a fracture conductivity of the reservoir.

8. A system for configuring a well for hydraulic fracturing, the system comprising:
at least one processor; and
a memory storing instructions, that, when executed by the at least one processor, cause the at least one processor to perform operations comprising:
obtaining reservoir data representing one or more features of a reservoir, the reservoir data comprising, for each of the one or more features, a set of values that satisfy a probability distribution associated with that feature;
performing a geological simulation of hydraulic fracturing in the reservoir, the geological simulation generating a production estimate for a well based on the reservoir data, the production estimate associated with the one or more features;
generating training data using the production estimate associated with the one or more features;
training, using the training data, a machine learning model to predict a fracture half-length value of the reservoir, the fracture half-length value corresponding to the hydraulic fracturing represented by the training data; and
determining, based on the training, a history-matched value for the fracture half-length of the reservoir.

9. The system of claim 8, the operations further comprising:
based on the a history-matched value for the fracture half-length, determining a cluster spacing in a horizontal well, a stage depth in the horizontal well, or both the cluster spacing and the stage depth in the horizontal well for performing hydraulic fracturing.

10. The system of claim 9, the operations further comprising causing fracturing the horizontal well based on the cluster spacing in the horizontal well, the stage depth in the horizontal well, or both the cluster spacing and the stage depth in the horizontal well.

11. The system of claim 8, wherein the features include one or more of a gas production rate, a depth of a well, a producing gas-oil ratio, a reservoir temperature, a tubing diameter, a gas gravity, a bottomhole pressure of a well, a reservoir pressure, a permeability of the reservoir, a porosity of the reservoir, a number of fractures associated with a well, a lateral length of a well, and a formation thickness.

12. The system of claim 8, wherein the reservoir data comprise a Monte Carlo sampling of values for each of the one or more features, the values satisfying the probability distribution associated with each feature.

13. The system of claim 8, the operations further comprising:
determining that a mismatch exists between a production history of the reservoir and an output of the geological simulation of hydraulic fracturing in the reservoir; and
updating the geological simulation to change an inputted fracture half-length value of the reservoir data.

14. The system of claim 8, wherein the machine learning model is further trained to predict the fracture half-length of the reservoir based on a porosity of the reservoir, a permeability of the reservoir, a net pay of the reservoir, a relative permeability of the reservoir, and a fracture conductivity of the reservoir.

15. One or more non-transitory computer readable media storing instructions for configuring a well for hydraulic fracturing, the instructions, when executed by at least one processor, configured to cause the at least one processor to perform operations comprising:
obtaining reservoir data representing one or more features of a reservoir, the reservoir data comprising, for each of the one or more features, a set of values that satisfy a probability distribution associated with that feature;
performing a geological simulation of hydraulic fracturing in the reservoir, the geological simulation generating a production estimate for a well based on the reservoir data, the production estimate associated with the one or more features;
generating training data using the production estimate associated with the one or more features;
training, using the training data, a machine learning model to predict a fracture half-length value of the reservoir, the fracture half-length value corresponding to the hydraulic fracturing represented by the training data; and
determining, based on the training, a history-matched value for the fracture half-length of the reservoir.

16. The one or more non-transitory computer readable media of claim 15, the operations further comprising:
based on the a history-matched value for the fracture half-length, determining a cluster spacing in a horizontal well, a stage depth in the horizontal well, or both the cluster spacing and the stage depth in the horizontal well for performing hydraulic fracturing.

17. The one or more non-transitory computer readable media of claim 16, the operations further comprising causing fracturing the horizontal well based on the cluster spacing in the horizontal well, the stage depth in the horizontal well, or both the cluster spacing and the stage depth in the horizontal well.

18. The one or more non-transitory computer readable media of claim 15, wherein the features include one or more of a gas production rate, a depth of a well, a producing gas-oil ratio, a reservoir temperature, a tubing diameter, a gas gravity, a bottomhole pressure of a well, a reservoir pressure, a permeability of the reservoir, a porosity of the reservoir, a number of fractures associated with a well, a lateral length of a well, and a formation thickness.

19. The one or more non-transitory computer readable media of claim 15, wherein the reservoir data comprise a Monte Carlo sampling of values for each of the one or more features, the values satisfying the probability distribution associated with each feature.

20. The one or more non-transitory computer readable media of claim 15, the operations further comprising:
determining that a mismatch exists between a production history of the reservoir and an output of the geological simulation of hydraulic fracturing in the reservoir; and
updating the geological simulation to change an inputted fracture half-length value of the reservoir data.
